(19) United States
(12) Patent Application Publication
(10) Pub. No.: US 2013/0271319 A1
(43) Pub. Date: Oct. 17, 2013

(54) METHOD AND SYSTEM FOR AIMING AND ALIGNING SELF-INSTALLED BROADCAST SIGNAL RECEIVERS

(71) Applicant: Alan Trerise, Los Gatos, CA (US)

(72) Inventor: Alan Trerise, Los Gatos, CA (US)

(21) Appl. No.: 13/861,575

(22) Filed: Apr. 12, 2013

Related U.S. Application Data
(60) Provisional application No. 61/623,263, filed on Apr. 12, 2012.

(51) Int. Cl. H01Q 1/12

(52) U.S. Cl. CPC H01Q 1/125
USPC 342/359

(57) ABSTRACT

A signal reception assembly may be installed by a user, and configured to achieve optimal alignment (e.g., perfect or near-perfect alignment) with a particular signal source. The signal reception assembly may receive signals from the signal source, and signal related information may be determined based on processing of the received signals, with the signal related data comprising parameters pertinent to configuring reception of signals from the particular signal source. An electronic device may be coupled to the signal reception assembly, and may be utilized to obtain and/or determine positioning information which may correlate with the positing of the signal reception assembly. Adjustments to aiming and/or alignment of the signal reception assembly, relative to the particular signal source, may be determined based on the positioning information and the signal related data to achieve the optimal alignment.

### CLAIM OF PRIORITY

This patent application makes reference to, claims priority to and claims benefit from the U.S. Provisional Patent Application Ser. No. 61/623,263, filed on Apr. 12, 2012, and entitled “METHOD AND SYSTEM FOR FREE-TO-AIR SELF INSTALL.”

This patent application also makes reference to:
U.S. Provisional Patent Application Ser. No. 61/623,271, which was filed on Apr. 12, 2012, and entitled “METHOD AND SYSTEM FOR A SATELLITE DISH OR ANTENNA WITH AN INTEGRATED DOCKING STATION;”
U.S. Provisional Patent Application Ser. No. 61/623,275, which was filed on Apr. 12, 2012, and entitled “METHOD AND SYSTEM FOR A MOBILE APPLICATION (APP) THAT ASSISTS WITH AIMING OR ALIGNING A SATELLITE DISH OR ANTENNA;”
U.S. patent application Ser. No. 13/715,250 filed on Dec. 14, 2012, and entitled “METHOD AND SYSTEM FOR A MESH NETWORK OF SATELLITE RECEPTION ASSEMBLIES;”
U.S. patent application Ser. No. 13/687,742 filed on Nov. 28, 2012, and entitled “METHOD AND SYSTEM FOR AN INTERNET PROTOCOL LNB (IP LNB) SUPPORTING POSITIONING;”
U.S. patent application Ser. No. 13/687,676 filed on Nov. 28, 2012, and entitled “METHOD AND SYSTEM FOR MONITORING, MANAGEMENT AND MAINTENANCE OF AN INTERNET PROTOCOL LNB;”
U.S. patent application Ser. No. 13/687,626 filed on Nov. 28, 2012, and entitled “METHOD AND SYSTEM FOR AN INTERNET PROTOCOL LNB SUPPORTING SENSORS;”
U.S. patent application Ser. No. 13/596,852, which was filed on Feb. 6, 2012, and entitled “METHOD AND SYSTEM FOR MOBILE DELIVERY OF BROADCAST CONTENT;”
U.S. patent application Ser. No. 13/326,125, which was filed on Dec. 14, 2011, and entitled “SYSTEM AND METHOD IN A BROADBAND RECEIVER FOR EFFICIENTLY RECEIVING AND PROCESSING SIGNALS;” and
U.S. patent application Ser. No. 13/301,400, which was filed on Nov. 21, 2011, and entitled “METHOD AND SYSTEM FOR PROVIDING SATELLITE TELEVISION SERVICE TO A PREMISES.”

Each of the above stated applications is hereby incorporated herein by reference in its entirety.

### TECHNICAL FIELD

Aspects of the present application relate to communications. More specifically, certain implementations of the present disclosure relate to aiming and aligning self-installed broadcast signal receivers.

### BACKGROUND

Existing methods and systems for installing and aligning a receiver used in receiving various wireless signals can be cumbersome and inefficient. Further limitations and disadvantages of conventional and traditional approaches will become apparent to one of skill in the art, through comparison of such approaches with some aspects of the present method and apparatus set forth in the remainder of this disclosure with reference to the drawings.

### BRIEF SUMMARY

A system and/or method is provided for aiming and aligning self-installed broadcast signal receivers, substantially as shown in and/or described in connection with at least one of the figures, as set forth more completely in the claims.

These and other advantages, aspects and novel features of the present disclosure, as well as details of illustrated implementation(s) thereof, will be more fully understood from the following description and drawings.

### BRIEF DESCRIPTION OF SEVERAL VIEWS OF THE DRAWINGS

FIG. 1 illustrates an example satellite television network, which may be used in accordance with various exemplary implementations of the invention.

FIG. 2 illustrates an example satellite receiver assembly that supports user or installer applied aiming and/or aligning, in accordance with an exemplary implementation of the invention.

FIG. 3 illustrates an example electronic device that may support user or installer applied aiming and/or aligning of signal receivers, in accordance with an exemplary implementation of the invention.

FIG. 4A illustrates an example interface of an application for use in an electronic device during installation of signal receivers.

FIG. 4B illustrates an example interface of an application for use in an electronic device during aligning of user-installed signal receivers.

FIG. 4C illustrates another example interface of an application for use in an electronic device during aligning of user-installed signal receivers.

FIG. 5 is a flow chart that illustrates example process for alignment of a broadcast signal receiver utilizing an electronic device, in accordance with an exemplary implementation of the invention.

### DETAILED DESCRIPTION

Certain embodiments of the invention may be found in method and system for aiming and aligning self-installed broadcast signal receivers. In accordance with various exemplary embodiments of the invention, a signal reception assembly may be configured to receive signals originating from a particular signal source. Based on processing of the received signals, signal related data may be determined. In this regard, the signal related data comprises parameters pertinent to configuring reception of signals from the particular signal source. An electronic device may be coupled to the signal reception assembly, and may be utilized to obtain and/or determine positioning information, which may comprise one or both of location and directionality related parameters. In this regard, the electronic device may be coupled to the signal reception assembly such that positioning of the electronic device correlates with positioning of the signal reception assembly. Based on the positioning information and the signal related data, adjustments to aiming and/or alignment of the signal reception assembly relative to the particular signal source, to achieve optimal alignment (e.g., perfect or near-perfect alignment) may be determined. The signal reception assembly may comprise a satellite reception assembly, with the particular signal source being a satellite. The electronic device may comprise a smartphone, a cellular phone, a tablet, or the like. The electronic device may be coupled to the signal reception assembly by docking the electronic device onto a component of the signal reception assembly. In this regard, the component of the signal reception assembly may comprise a signal capturing component. For example, the signal capturing component may comprise a low noise block downconverter (LNB) in instances where the signal reception assembly may be a satellite reception assembly. Processing the received signals, to obtain the signal related information, may be performed by the signal reception assembly and/or a separate signal processing device. In this regard, the separate signal processing device may comprise a broadband gateway, a satellite set-top box (STB), or a local network router.

The electronic device may be configured to present the one or more adjustments to the aiming or alignment of the signal reception assembly to a user (e.g. end-user or installer) of the signal reception assembly. The particular signal source may be selected by the user of the signal reception assembly. In this regard, the electronic device may be configured to present the plurality of available signal sources to the user of the signal reception assembly. The electronic device may be configured to run an application for aiding a user of the signal reception assembly during selection, aiming, and/or aligning of the signal reception assembly.

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first plurality of lines of code and may comprise a second “circuit” when executing a second plurality of lines of code. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the terms “block” and “module” refer to functions than can be performed by one or more circuits. As utilized herein, the term “exemplary” means serving as a non-limiting example, instance, or illustration. As utilized herein, the terms “for example” and “e.g.,” introduce a list of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled, or not enabled, by some user-configurable setting.

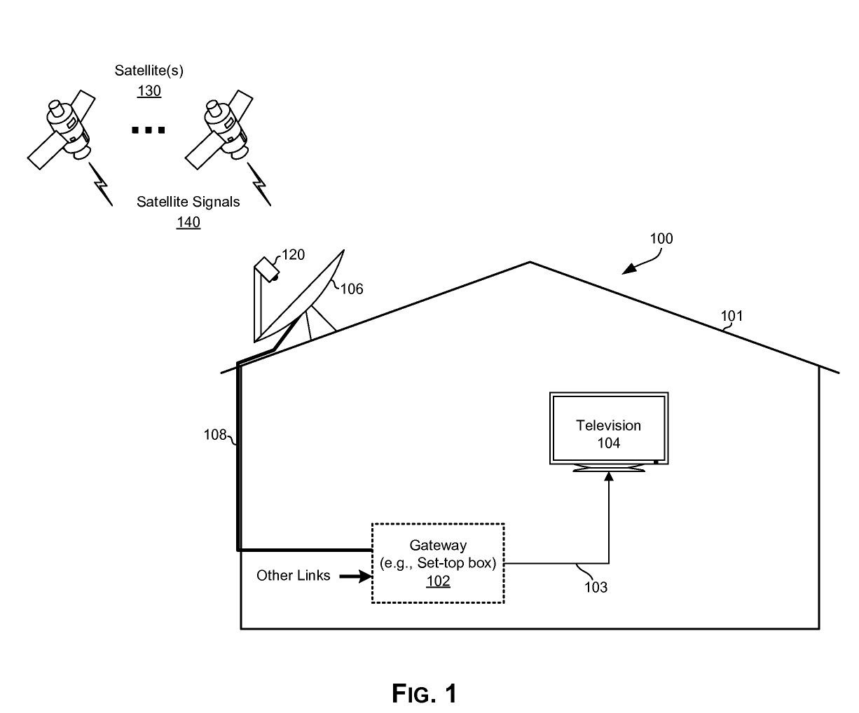

FIG. 1 illustrates an example satellite television network, which may be used in accordance with various exemplary implementations of the invention. Referring to FIG. 1, there is shown an in-premises network 100, a satellite reception assembly 106, a plurality of satellites 130, and a network link 108 for connecting the satellite reception assembly 106 and the in-premises network 100.

The in-premises network 100 may be setup and/or configured to service particular premises 101 (e.g., residential or commercial). In this regard, the in-premises network 100 may facilitate providing broadband and/or television (or other similar content broadcast) access in the premises 101. The in-premises network 100 may comprise, for example, a gateway 102 and a plurality of client devices, of which a television 104 is shown.

The plurality of satellites 130 may be utilized to transmit (beam down) satellite signals 140. In this regard, the satellite signals 140 may be utilized to broadcast satellite television content. The satellite signals 140 may comprise, for example, K, Ka, and/or Ku band Direct Broadcast Satellite (DBS) signals. The disclosure, however, is not limited to any particular type of satellite signals.

The satellite reception assembly 106 may be a satellite “dish”. In this regard, the satellite reception assembly 106 may comprise a reflector—for capturing satellite signals (e.g., the satellite signals 140), and circuitry operable to receive and to process the received satellite signals, such as to recover data carried in the satellite signals (e.g., television channels, media content, etc.), and configure a suitable output corresponding to the recovered data for transmission to other devices that may handle use and/or distribution of the data (e.g., to the gateway 102 via the network link 108). The satellite reception assembly 106 may comprise a housing 120. In this regard, the housing 120 may be, for example, part of the satellite reception assembly 106 (e.g., it may be mounted on a boom at or near the focal point of a parabolic reflector), and may comprise circuitry for capturing and handling satellite signals. For example, the housing 120 may comprise a circuitry corresponding to a low noise block downconverter (LNB), and additional circuitry (e.g., a link driver). In this regard, the LNB may be operable to receive and handle RF satellite signals, which may be captured via the reflector of a satellite reception assembly 106. The LNB may be configured to perform such functions as low-noise amplification, filtering, and downconverting on a particular received RF (satellite) signals, to enable generating corresponding IF signals. For example, the IF signals may be in the L-band, half-L-band (950-1450 MHz), extended-L-band (250-2150 MHz, 300-2350 MHz), and the like. The disclosure, however, is not so limited, and the IF signals may span any suitable frequency range. In some instances, the satellite receiver assembly 106, and/or various components thereof (e.g., the housing 120), may require power. For example, the power may be needed to enable remote movement of the reflector of the satellite receiver assembly 106 and/or to enable processing performed in and/or by the LNB (and other circuitry—e.g., the link drivers). Power may typically be provided to the satellite receiver assembly 106 in the form of a power cable or cord. In this regard, a power cord may be extend to the satellite receiver assembly 106 form the premises 101 (e.g., from an outlet in or outside the premises 101, or from another device therein, such as the gateway 102).

The network link 108 may comprise one or more wired, wireless, and/or optical links. The network link 108 may comprise, for example, a wired (e.g., coaxial and/or twisted-pair) and/or wireless communication medium which carries physical layer symbols in accordance with, for example, Multimedia over Coax Alliance (MoCA), Ethernet, and/or DBS standards. In some instances, the gateway 102 may be configured to terminate other communication links (not shown), which may comprise, for example, a coaxial or twisted-pair cable and/or an optical fiber which carries physical layer symbols in accordance with, for example, DSL, DOCSIS, or Ethernet standards (e.g., to facilitate cable television, terrestrial television, and/or Internet accessibility). In some instances, power cords used to supply power to the satellite receiver assembly 106 may also be utilized in communication of data (in addition to supplying power) to and/or from the satellite receiver assembly 106. For example, the power cord may be utilized (as medium) for setting and/or using Power line communication (PLC), such us using HomePlug based specifications.

The gateway 102 may comprise circuitry operable to receive the signals communicated over a plurality of links (e.g., the network link 108), process the signals as necessary for outputting information contained therein via a plurality of internal links 103 within the in-premises network 100. In the regard, the plurality of internal links 103 may comprise wired, wireless, and/or optical links that may be suited for use in an environment such as the in-promises network 100. For example, the internal links 103 may comprise wired connections (e.g., HDMI connections, Display Port links, MoCA links, or Ethernet connection), and/or wireless connections (e.g., Wi-Fi, ZigBee, wireless USB, or the like). The gateway 102 may also comprise circuitry operable to transmit signals via the network link 108 and/or any other external links (i.e., links connecting the gateway 102 to external entities, such as broadcast or service head-ends). Accordingly, the term “gateway” in this disclosure refers to a client device which may perform satellite set-top box functions, cable television receiver functions, terrestrial television receiver functions, WAN/LAN modem functions, etc. In this regard, “satellite set-top box” functions may comprise functions necessary for delivering data from the satellite reception assembly 106 to devices within the premises. The gateway 102 may be configured to service a plurality of client devices, which may comprise devices that may communicate with the gateway 102 via one or more point-to-point media links (e.g., HDMI, Display Port, analog video links, analog video links, or the like). An example of such client devices is televisions (e.g., the television 104) and similar devices that may be used in displaying or playing back multimedia content that may be broadcasted (e.g., via terrestrial signals, satellite signal, cable signal, and/or over the Internet).

In operation, the in-premises network 100 may be setup and/or used to provide various services (e.g., broadband and/or television access) within the premises 101. In this regard, the in-premises network 100 may comprise a network configured based on one or more types of interfaces or standards, to interconnect various devices, particularly the gateway 102 and client devices (e.g., the television 104), within a physical space (e.g., the premises 101) to each other and/or to access networks. For example, the in-premises network 100 may be setup as Internet Protocol (IP) based network, using WiFi, Ethernet, Bluetooth, and/or similar connections, and may be configured to support various IP-based services such as Broadband or IP-based TV (IPTV) services.

In an exemplary aspect of the invention, some of the data utilized in the in-premises network 100 may be received from external sources, such as broadband or broadcast sources. In this regard, the gateway 102 may be utilized to service the in-premises network 100, such as by providing broadband and/or broadcast (e.g. television or other content) access to a plurality of client devices (e.g., the television 104) within the in-premises network 100. In this regard, the gateway 102 may receive signals carrying content that may be forwarded to the client devices for use thereby. For example, the content used (e.g., displayed/played) by the television 104 may be based on satellite television broadcasts. In this regard, the satellite reception assembly 106 may be configured to receive the satellite signals 140, and to process the receive signals and generate corresponding signals (e.g., comprising content carried by the received signals) that may be fed into the gateway 102 (via the network link 108) for use within the in-premises network 100 (e.g., being forwarded to the television 104 via corresponding local links 103).

In an exemplary aspect of the invention, users (e.g. end-user or installer) may be allowed to self-install particular components of the in-premises network 100, such as the satellite reception assembly 106. In this regard, user self-installation of a component such as the satellite reception assembly 106 may require installing it where it may be used to receive signals from particular desired sources (e.g., on the roof), connecting to the other components (e.g., the gateway 102), and/or in some instances ensuring power supply (e.g., using power cords plugged to an outlet in or external to the premises 101). In addition to these steps, in some instances, additional steps or actions may also be necessary. For example, with signal reception components, such as the satellite reception assembly 106, it may be necessary to also aim and/or align the signal receivers based on the location or position of desired signal sources relative to the signal receiver. In this regard, to ensure proper and/or optimal reception of signals (e.g., satellite signals 140) from external sources (e.g., satellites 130), components used in the reception of the signals (e.g., the satellite reception assembly 106) may need to be aimed such that they may be aligned perfected (or near-perfectly) with the signal sources. For example, because different satellites 130 may different orbit profiles (e.g., having different orbit type—such as based on altitude, inclination, eccentricity, and/or synchronicity; with different parameters, such as different coordinates, altitude, velocity, etc.), receiving signals from particular one or more satellites 130 may require particular aim and alignment of the satellite reception assembly 106.

Accordingly, in various implementations of the invention, users (e.g. end-user or installer) may be enabled to also aim and/or align signal receivers during self-installation, such as based on information about signal sources, information obtained from received signals, and/or location/positioning information pertaining to the signal receiver. For example, an electronic device (e.g., smartphone or the like) may be used to obtain information regarding available signals sources corresponding to particular signal receiver (e.g., available satellites when the signal receiver is a satellite dish). The electronic device may then be used to enable aiming and/or aligning the signal receiver towards particular signal source (e.g., selected by the user). For example, the aiming or aligning of the signal receiver may be achieved by applying an initial aiming of the signal receiver (e.g., based on available information regarding the signal source); then receiving and processing signals from the source (e.g., to obtain information that may be pertinent to the aiming/alignment, such as signal strength, noise, polarization, etc.); and then optimizing the alignment of the signal receiver by providing the user with information needed to achieve the perfect alignment (e.g., based on determination of required adjustments, which may be determined from the processing of already received signals). An example implementation is described with respect to at least some of the following figures. While some of the implementations disclosed herein are described with regard to satellite receivers (dishes) and satellite signals, the disclosure is not limited as such. Accordingly, similar implementations may be used with respect to other signal receivers/sources (e.g., terrestrial TV broadcast and terrestrial TV antennas, microwave/millimeter wave point-to-point signal source and antenna, or the like), whereby alignment of the signal receiver relative to the signal source may be required and/or desired.

In some instances, the in-premises network 100 may be integrated into and/or interacts with a larger network. For example, in instances where the satellite reception assembly 106 may be configured to support Internet Protocol LNB (IPLNB) based services, whereby available links (e.g., using femtocell, and picocell communication) may be used to communicated with other nearby premises to allow distribution and/or sharing of content via a plurality of different media. Accordingly, content obtained based on user self-installation as described herein (e.g., both satellite TV channels and free-to-air TV channels) may be combined or integrated with the following: neighborhood IPLNB network, IPLNB mesh network (e.g., combining different wireless communications, such as WiFi, cellular, femtocell, picocell, and terrestrial TV at a dish, for wireless network connectivity), and/or connecting a terrestrial TV antenna to an input on the IPLNB.

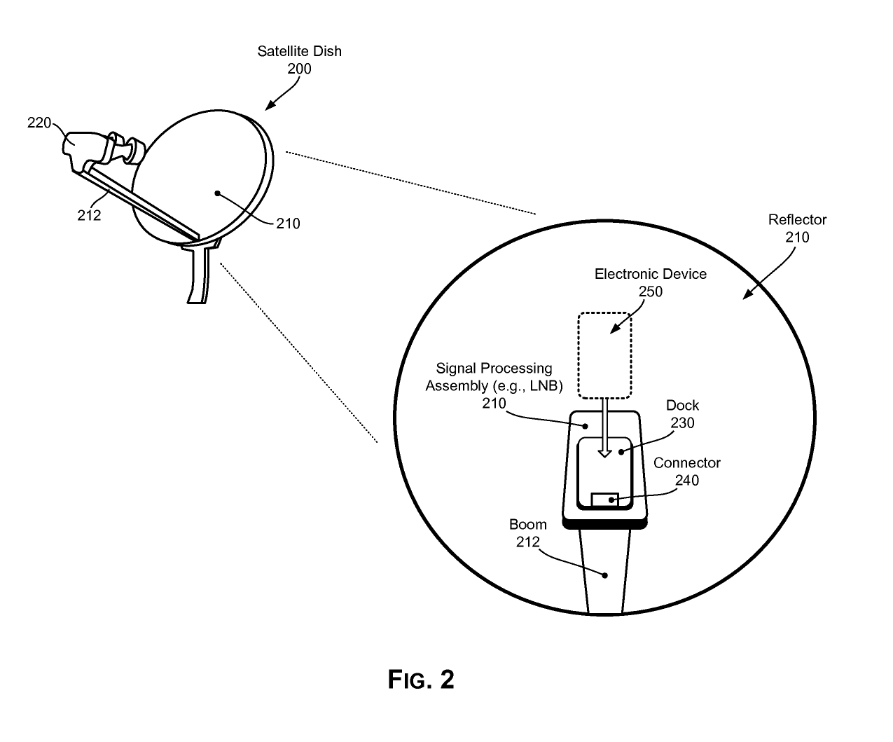

FIG. 2 illustrates an example satellite receiver assembly that supports user (e.g. end-user or installer) applied aiming and/or aligning, in accordance with an exemplary implementation of the invention. Referring to FIG. 2, there is shown a satellite receiver (‘dish’) assembly 200 and an electronic device 250.

The satellite dish assembly 200 may be configured to support capturing of satellite signals, and handling of the received signals (e.g., to provide feed to other devices, such as satellite set-top boxes or other devices that can extract and process satellite content). The satellite dish assembly 200 may be similar to the satellite reception assembly 106 of FIG. 1. The satellite dish assembly 200 may comprise a reflector 210, a boom 212, and a signal processing assembly 220. In this regard, the reflector 210 may be a concave structure for reflecting electromagnetic waves (e.g., satellite signals) toward a focal point. The reflector 210 may be substantially parabolic in shape and may be made of, for example, fiberglass and/or metal. The boom 104 may be configured to enable the signal processing assembly 220 to be mounted at or near the focal point of the reflector 210. The signal processing assembly 220 may comprise circuitry for receiving and processing satellite signals. The signal processing assembly 220 may comprise circuitry for implementing a low-noise block downconversion (LNB) function. Furthermore, although the signal processing assembly 220 may be colloquially referred to as a “low-noise block downconverter” or “LNB,” in various example implementations it may comprise circuitry operable to perform functions beyond block downconversion of received satellite signals. In the depicted implementation, the signal processing assembly 220 is depicted as a single physical assembly mounted to the satellite dish assembly (i.e., it is a subassembly of the satellite dish assembly). In other implementations, however, the signal processing assembly 220 may comprise multiple physical assemblies, one or more of which may reside physically separate from the satellite dish assembly and be connected to the satellite dish via one or more wired and/or wireless links.

In an exemplary aspect of the invention, the satellite dish assembly 200 may be configured to support user (e.g. end-user or installer) self-installation, aiming and/or alignment. For example, the satellite dish assembly 200 may be configured to support use of personal electronic device (e.g., the electronic device 250) to allow a user to achieve perfect (or near-perfect) aiming or alignment of the signal reception by the satellite dish assembly 200 in relation to particular, desired source (satellite). In this regard, the satellite dish assembly 200 may incorporate, for example, a docking station (‘dock’) 230, to enable attaching (docking) the electronic device 250, such as via a connector 240. The connector 240 may comprise, for example, a Universal Serial Bus (USB) based connector or the like. The disclosure, however, is not so limited, and any type of connector/interface (wired or wireless) deemed suitable may be utilized.

The electronic device 250 may comprise suitable circuitry, interfaces, logic, and/or code for implementing various aspects of the inventions. In this regard, the electronic device may be configured to support communication operations, processing or handling of data, input/output operations, or the like. For example, the electronic device 250 may enable and/or support communication of data, such as via wired and/or wireless connections, which may be configured in accordance with one or more supported wireless and/or wired protocols or standards. To support input/output operations, the electronic device 250 may comprise components or subsystems for enabling interactions with a user (e.g. end-user or installer), so as to obtain user input and/or to provide user output. In some instances, the electronic device 250 may be a handheld mobile device—i.e., be intended for use on the move and/or at different locations. In this regard, the electronic device 250 may be designed and/or configured to allow for ease of movement, such as to allow it to be readily moved while being held by the user as the user moves, and the electronic device 250 may be configured to perform at least some of the operations, functions, applications and/or services supported by the device on the move. Examples of electronic devices may comprise cellular phones, smartphones, and/or tablets. The disclosure, however, is not limited to any particular type of electronic device.

In operation, the satellite dish 200 may be configured to allow user (e.g. end-user or installer) self-installation, aiming and alignment. In this regard, the satellite dish 200 may be installed by a user. The satellite dish may then preliminarily be aimed towards a particular signal source (satellite). For example, the user may obtain a listing of available satellites, along with pertinent information associated with the available satellite. In this regard, the pertinent information may comprise, for example, available channels offered by each satellite, location information (e.g., orbit related data) for each satellite, and the like. In an example implementation, the listing of available satellite (and related information) may be obtained using the electronic device 250. The user may then aim the satellite dish, using the electronic device 250. In this regard, the electronic device 250 may be coupled to the satellite dish in a manner that allows correlating information obtained by the electronic device 250 with the satellite dish 200. For example, the electronic device 250 may be docked onto the dock 230, using the connector 240.

The satellite dish 200 may then be used to captured some satellite signals, and the signals may be processed (e.g., by the LNB 210 and/or other external signal processing devices, such as gateways, STBs, or routers/bridges in IPLNB based networks). Processing the received signals may enable obtaining signal related information which may be utilized in aiming and/or alignment of the satellite dish. For example, processing received signals may enable confirming that the current satellite to which the satellite dish 200 is aimed is the satellite desired/selected by the user (e.g., the selection can be made via the electronic device 250, based on the presentation of available satellite thereby). The signal related information may also comprise signal specific parameters (e.g., signal strength, noise, polarization, etc.).

Once the satellite dish 200 is preliminarily aimed, it may be optimally aligned—i.e., to achieve perfect (or near-perfect) alignment with the selected satellite. In this regard, the optimal alignment of the satellite dish 200 may achieved by determining precise positioning information (e.g., location and directionality) for the satellite dish, and using that positioning information and/or the signal information, to achieve the optimal alignment. In some instances, the electronic device 250 may be utilized in achieving the optimal alignment. In this regard, use of electronic devices (such as the electronic device 250) may be used to mitigate the need to incorporate additional/dedicated components and/or functions into the satellite dish 200 while taking advantage of components and/or functions that may already be available in the electronic device 250. Nonetheless, the disclosure is not so limited—i.e., with respect to the user of electronic devices. Accordingly, in some implementations, at least some of the components and/or functions described with respect to the electronic devices (e.g., the electronic device 250) may be incorporated directly into and/or performed by the signal receivers (e.g., the satellite dish itself, such as part of the LNB 210). For example, LNB 210 (or the satellite dish 200 as a whole) may simply incorporate resources needed to allow providing at least some of the functions described with respect to the electronic device 250 (e.g., positioning determination, obtaining signal source related data, user feedback/aid, etc.).

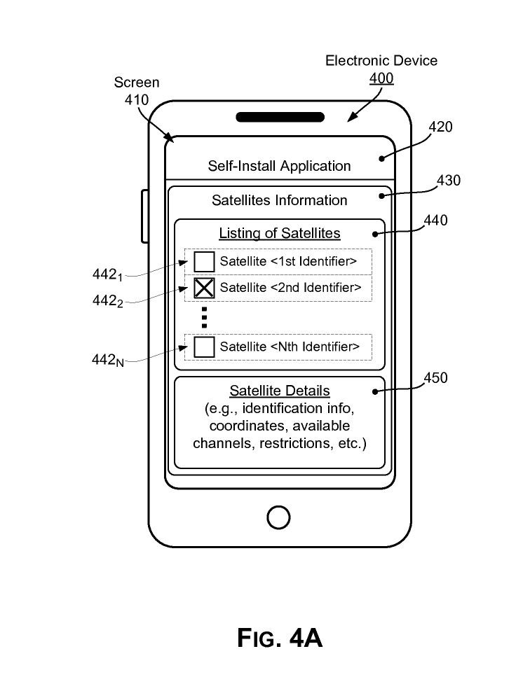

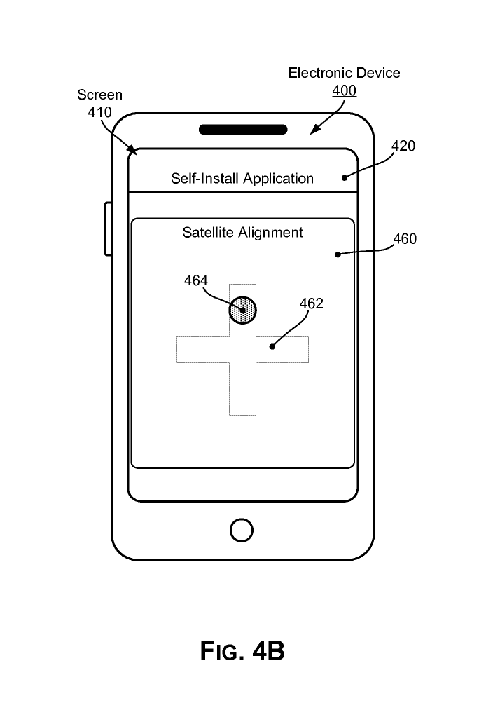

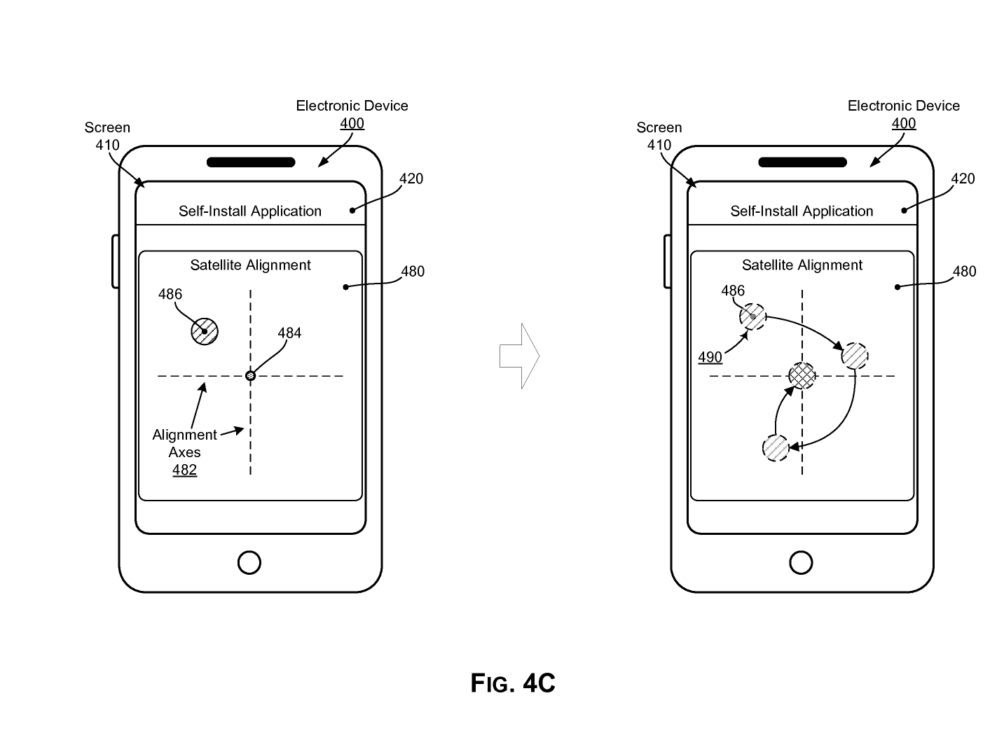

The electronic device 250 may utilize already available sensors and/or sources (e.g., network connections) to determine or obtain positioning information corresponding to the electronic device 250 (i.e., information regarding location and/or directionality of the electronic device 250). That information may then be used in aligning the satellite dish 200 since positioning of the electronic device 250 may correlate with the positioning of the satellite dish 200 (by virtue of the electronic device 250 being docked into the satellite dish 200). Thus, the electronic device 250 may be utilized to simplify the determining of the positioning information of the satellite dish 200, which in turn may be used in determining the necessary adjustments (to the satellite dish 200) to achieve the optimal alignment. In some instances, the electronic device 250 may be utilized to aid and/or guide the user in aligning the satellite dish, such as by providing indication on what need to be done to achieve the optimal alignment. For example, the electronic device 250 may be configured to provide a visual/graphical indication on current alignment of the satellite dish 200, and/or the would-be-need adjustments to achieve the optimal alignment, as described in more detail with respect to FIGS. 4A-4C, below.

In an example implementation, the electronic device 250 may be configured to run and/or execute a dedicated application for aiding users (e.g., an end-user or installer) during self-installation, aiming and/or alignment of signal receivers (such as the satellite dish 200). In this regard, the application run in the electronic device 250 may be utilized to obtain and/or present information pertinent to the self-installation process (e.g., regarding available signal sources and/or the selection of signal sources), and/or to obtain, determine and/or present information pertinent to the aiming or aligning of the signal receivers, to achieve the optimal alignment. An example of such application is described in more detail with respect to FIGS. 4A-4C.

In an example implementation, the setup shown in FIG. 2 may be configured as an Internet Protocol LNB (IPLNB) based implementation. In this regard, the LNB 210 may be implemented as IP LNB. The satellite dish 200 may be connected to a power outlet (external or within premises), which may also be used to allow communication of signals between the satellite dish 200 and other devices (e.g., WiFi bridge or router, or the like) over power lines (e.g., using HomePlug or other PLC based links), which may be utilized in processing content obtained from satellite signals received via the satellite dish 200. In this regard, such HomePlug based links may not require direct coupling—e.g., the other devices may be plugged into another outlet in the premises. In some instances, signals received by the satellite dish 200 may be sent (in some instances, after partial processing via the LNB 210) to the other devices, which may further process these received signals (e.g., to obtain signal related information that may pertinent to the aligning of the satellite dish 200). The electronic device 250 may then be able to obtain that information (e.g., the signal related information) directly from the other devices (e.g., using WiFi connections or the like).

While the implementation shown in FIG. 2 incorporates direct attachment (docking) of the electronic device 250, the disclosure is not so limited. Rather, in some implementations, use of electronic devices (e.g., the electronic device 250) may not require attaching (e.g., docking) of the electronic devices directly to the signal reception assemblies (e.g., the satellite dish 200). For example, in some implementations the electronic device 250 may simply be held away from (and in common directionality and positioning with) the satellite dish 200 while still being used to obtain and/or provide information pertinent to the installation, aiming and alignment of the satellite dish 200. In this regard, the electronic device 250 may communicate wirelessly with the satellite dish 200 (e.g., to correlate their positioning), or it (the electronic device 250) may simply operate independently of the satellite dish 200 since it may be presumed that they would be in such close proximity of each other that positioning of the electronic device 250 may sufficiently proximate the positioning of the satellite dish 200.

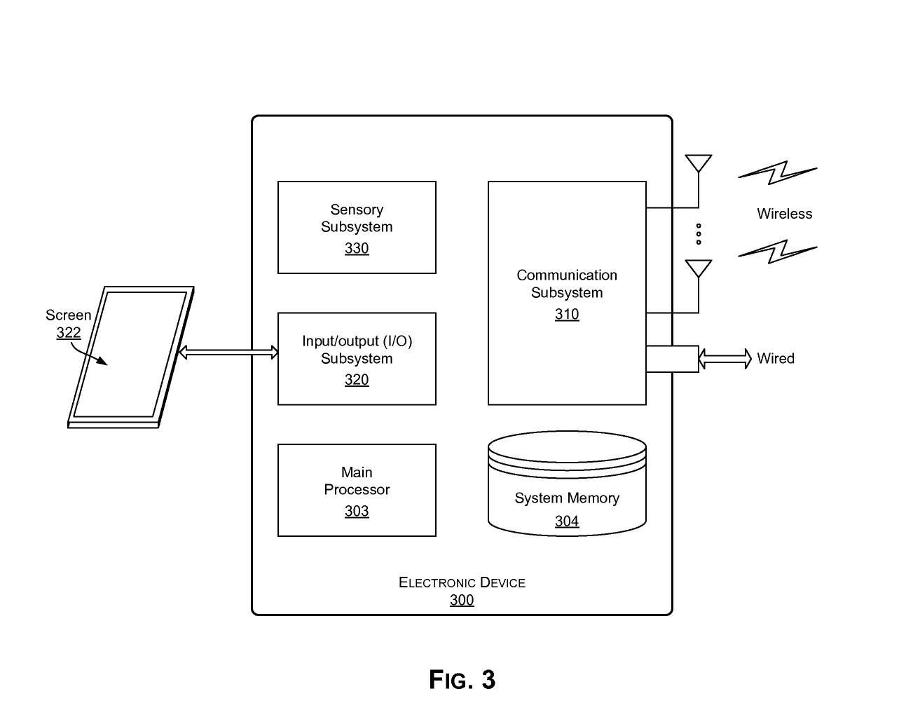

FIG. 3 illustrates an example electronic device that may support user (e.g. end-user or installer) applied aiming and/or aligning of signal receivers, in accordance with an exemplary implementation of the invention. Referring to FIG. 3, there is shown an electronic device 300.

The electronic device 300 may comprise suitable circuitry, interfaces, logic, and/or code that may be operable to implement various aspects of the present disclosure. In this regard, the electronic device 300 may correspond to the electronic device 100 of FIG. 1 for example. The electronic device 300 may comprise, for example, a main processor 302, a system memory 304, a communication subsystem 310, an input/output (I/O) subsystem 320, and a sensory subsystem 330.

The main processor 302 may comprise suitable circuitry, interfaces, logic, and/or code that may be operable to process data, and/or control and/or manage operations of the electronic device 300, and/or tasks and/or applications performed therein. In this regard, the main processor 302 may configure and/or control operations of various components and/or subsystems of the electronic device 300, by utilizing, for example, one or more control signals. The main processor 302 may enable running and/or execution of applications, programs and/or code, which may be stored, for example, in the system memory 304. Alternatively, one or more dedicated application processors may be utilized for running and/or executing applications (or programs) in the electronic device 300. The main processor 302 may comprise a general purpose processor (e.g., CPU), a special purpose processor (e.g., graphics processing unit or GPU, or a visual processing unit or VPU), or the like. The disclosure, however, is not limited to any particular type of processors.

The system memory 304 may comprise suitable circuitry, interfaces, logic, and/or code that may enable permanent and/or non-permanent storage, buffering, and/or fetching of data, code and/or other information, which may be used, consumed and/or processed. In this regard, the system memory 304 may comprise different memory technologies, including, for example, read-only memory (ROM), random access memory (RAM), Flash memory, solid-state drive (SSD), and/or field-programmable gate array (FPGA). The disclosure, however, is not limited to any particular type of memory or storage devices. The system memory 304 may store, for example, configuration data, which may comprise parameters and/or code, comprising software and/or firmware. The disclosure is not limited, however, to any particular type of configuration data.

The communication subsystem 310 may comprise suitable circuitry, interfaces, logic, and/or code operable to communicate data from and/or to the electronic device, such as via one or more wired and/or wireless connections. The communication subsystem 310 may be configured to support one or more wired protocols and/or interfaces, and/or one or more wireless protocols and/or interfaces, facilitating transmission and/or reception of signals to and/or from the electronic device 300 and/or processing of transmitted or received signals in accordance with applicable wired or wireless protocols. Examples of wireless protocols or standards that may be supported and/or used by the communication subsystem 310 comprise wireless personal area network (WPAN) protocols, such as Bluetooth (IEEE 802.15); near field communication (NFC) standards; wireless local area network (WLAN) protocols, such as WiFi (IEEE 802.11); cellular standards, such as 3G/2G+(e.g., GSM/GPRS/EDGE, and IS-95 or cdmaOne) and/or 3G/2G+(e.g., CDMA2000, UMTS, and HSPA); 4G standards, such as WiMAX (IEEE 802.16) and LTE; Ultra-Wideband (UWB), and/or the like. Examples of wired protocols and/or interfaces that may be supported and/or used by the communication subsystem 310 comprise Ethernet (IEEE 802.2), Fiber Distributed Data Interface (FDDI), Integrated Services Digital Network (ISDN), and Universal Serial Bus (USB) based interfaces. Examples of signal processing operations that may be performed by the communication subsystem 310 comprise, for example, filtering, amplification, analog-to-digital conversion and/or digital-to-analog conversion, up-conversion/down-conversion of baseband signals, encoding/decoding, encryption/decryption, and/or modulation/demodulation.

The I/O subsystem 320 may comprise suitable circuitry, interfaces, logic, and/or code for enabling and/or managing user (e.g. end-user or installer) interactions with the electronic device 300, such as obtaining input from, and/or to providing output to, the device user(s). The I/O subsystem 320 may support various types of inputs and/or outputs, including, for example, video, audio, and/or text. In this regard, dedicated I/O devices and/or components, external to (and coupled with) or integrated within the electronic device 300, may be utilized for inputting and/or outputting data during operations of the I/O subsystem 320. Examples of such dedicated I/O devices may comprise displays, audio I/O components (e.g., speakers and/or microphones), mice, keyboards, touch screens (or touchpads), and the like. In some instances, user input obtained via the I/O subsystem 320, may be used to configure and/or modify various functions of particular components or subsystems of the electronic device 300.

The sensory subsystem 320 may comprise suitable circuitry, interfaces, logic, and/or code for obtaining and/or generating sensory information, which may relate to the electronic device 300, its user(s), and/or its environment. For example, the sensory subsystem 320 may comprise ambient conditions (e.g., temperature, humidity, or light) sensors, positional or location sensors (e.g., GPS or other GNSS based sensors), and/or motion related sensors (e.g., accelerometer, gyroscope, pedometers, and/or altimeters).

In operation, the electronic device 300 may be utilized to support user (e.g., end-user or installer) self-installation of signal receivers, substantially as described with respect to the electronic device 250 of FIG. 2 for example. In this regard, the electronic device 300 may be operable to obtain (e.g., from suitable websites using Internet connections, setup over any available wireless and/or wired links) data regarding available signal sources (e.g., satellites, terrestrial TV broadcast nodes, and the like). The obtained data may then be presented (e.g. displayed via the screen 322, such as textual, graphical, and/or video content) to the user attempting to self-install a signal receiver (e.g., satellite dish, terrestrial TV antenna, or the like). The user may then utilize that data to select a particular signal source, and to preliminarily aim the signal receiver to receive signals from the selected signal source. For example, the available signal sources may be listed on the screen 322, and the user may then specify a particular source from the list (e.g., by clicking on it or by other means).

The electronic device 300 may then be utilized to hone and/or optimize the aiming/alignment of the signal receiver. For example, the electronic device 300 may obtain (e.g., using its sensory subsystem 330) aiming/alignment relevant data, such as positioning, location, and/or directional related data. The data may then be used (in some instances, in combination with signal related information obtained from any received signals) to determine the perfect (or near-perfect) alignment for the signal receiver, and/or any required adjustments to current settings (aim or alignment) of the signal receiver to achieve the determined perfect (or near-perfect) alignment. The signal related information may be determined based on processing of received signals. The processing may be performed by the signal receiver itself and/or by other devices (e.g., a gateway, a set-top box, a router or bridge in IPLNB based network, etc.). The processing of the received signals may enable obtaining the signal related information, which may comprise parameters relating to, for example, signal strength, polarization, noise, etc. The signals related information may be pertinent to the aiming/alignment, such as by comparing with predefined or estimated signal related parameters corresponding to perfect (or near-perfect) alignment conditions.

In some implementations, the electronic device 300 may be docked directly onto the signal receiver (e.g., using connector 240 of the dock 230) in a manner to ensure that the positioning, location, and/or directionality of the electronic device 300 correlated with those of the signal receiver. The disclosure is not so limited, however, and some instances the electronic device 300 may be communicatively coupled to the signal receiver using wireless connections, with the adjustments being determined based on knowledge (as provided or determined) of the positioning, location, and/or directionality of the signal receiver relative to the electronic device 300.

In some implementations, the electronic device 300 may incorporate and/or run an application for use in support user self-installations (and particularly in assisting with achieving the optimized aiming/alignment of signal receiver). An example of such application is described in more detail with respect to FIGS. 4A-4C.

FIG. 4A illustrates an example interface of an application for use in an electronic device during installation of signal receivers. Referring to FIG. 4A, there is shown an electronic device 400.

The electronic device 400 may be similar to the electronic device 300, substantially as described with respect to FIG. 3 for example. In this regard, the electronic device 400 may comprise suitable circuitry, interfaces, logic, and/or code for supporting alignment and/or aiming of self-installed signal receivers, such as satellite receiver assemblies (e.g., satellite dish 200). The electronic device 400 may comprise, for example, processing resources, storage resources, and input/output (I/O) components or subsystems which may be needed for aiming/alignment related operations. For example, the electronic device 400 may comprise I/O components for enabling interactions with users (e.g. end-user or installer), such as to obtain user input and/or to provide user output. In an example implementation, the electronic device 400 may comprise a screen 410 (corresponding to screen 322 of FIG. 3), which may be used to support user interactivity with the electronic device 400. In this regard, the screen 410 may be used as an output component, such as to display video or still images. The screen 410 may also be configured to function as an input component. For example, the screen 410 may be configured as a touchscreen, whereby a user of the electronic device 400 may input commands or requests by means of physical contact with the screen 410 (e.g., by selecting a particular option by touching a particular area of the screen 410, or by enter text in suitable fields).

In operation, the electronic device 400 may be used during user self-installation of signals receiver (e.g., satellite receiver assemblies), and/or aiming or alignment thereof. For example, the electronic device 400 may be used to output (e.g., display) to the user and/or to obtain from the user (e.g., typing or touch-based selection) information that may be pertinent to selecting particular signal source (e.g. satellite), and/or to aim or align the signal receiver in the optimal direction to receive signals from the selected signal source. In some instances, the electronic device 400 may also obtain additional information relating to the installation, aiming and/or aligning of signal receivers. The additional information may comprise, for example, positioning, location or directional related data. In this regard, the additional information may be generated directly by the electronic device 400 and/or by other devices/systems with which the electronic device 400 may communicate. For example, the positioning, location or directional related data may be obtained directly by the electronic device 400 (e.g., using components, such as GPS, gyroscopic, compass and/or telemetric sensors) and/or from external sources—e.g., obtaining positioning related data from networks with which the electronic device 400 may communicate or by which the electronic device 400 may be serviced, such as cellular networks.

In some instances, the electronic device 400 may be configured to run or execute an application (e.g., self-install application) which may be used to support the user (e.g. end-user or installer) self-installation, aiming and aligning of signal receivers. In this regard, such application may be triggered automatically (e.g., when the electronic device 400 is connected to the signal receiver, such as using connector 240 of dock 230), or manually (e.g., in response to user input, launching the application). For example, an interface corresponding to the self-install application (e.g., in the form of a graphical user interface or GUI) may be displayed, on the screen 410 of the electronic device 400 to enabling outputting information to the user and/or to allow input by the user pertaining to self-installation process. The self-install application GUI 420 may comprise, for example, a plurality of sections, panes, and/or fields displaying self-install related information and/or allowing user self-install related input.

For example, as shown in FIG. 4A, when used with respect to self-installation and aiming/alignment of satellite receivers, the self-install application GUI 420 may comprise a satellite information pane 430, which may be used to display information regarding all satellites that the electronic device 400 may determine are available to obtain content from (both free and for-pay). In this regard, the electronic device 400 may determine the satellite availability (and/or information relating to each of the satellite) from other sources, such as using Internet connection to appropriate websites or the like. The disclosure, however, is not particular to any specific manner by which availability (and/or pertinent information) may be obtained.

In an example implementation, the satellite information pane 430 may comprise a ‘listing of satellites’ section 440, which may comprising a plurality of satellite identifier fields 442₁-442_{N} (listing N different identifier: satellite fields 1st identifier through Nth identifier) corresponding to all (N) identified (and determined to be available) satellites (where N is a non-negative integer). Each satellite identifier field 442ᵢ may also allow the user to select the corresponding satellite (e.g., for aiming and/or aligning thereto). For example, as shown in FIG. 4A, each satellite identifier field 442ᵢ may comprise clickable sub-field, which may be checked for selecting (and un-checked for deselecting) the corresponding satellite. In other words, the user may click a button to select/de-select the corresponding satellite.

The satellite information pane 430 may also comprise a ‘satellite details’ section 450, which may comprise detailed information pertaining to particular satellite (i.e., associated with a satellite corresponding to one of the satellite identifier fields 442₁-442_{N}). For example, the ‘satellite details’ section 450 may comprise such data identification information (e.g., satellite name, operator, etc.), coordinate information (e.g., information relating to orbit and/or position in space), content related information (e.g., broadcasts sources and/or channels included in the signals), restrictions (e.g., free or for-pay, and/or cost if for-pay), and the like). The displaying of the ‘satellite details’ section 450 may be done in various manners. For example, the ‘satellite details’ section 450 may be displayed for each satellite when the user scrolled into the corresponding satellite identifier field, or taps the screen above the satellite identifier field. Alternatively, each satellite identifier field 442ᵢ may incorporate a sub-field (not shown) for expressly requesting detailed information for a corresponding satellite, with the displaying of the ‘satellite details’ section 450 being triggered as result of selection of (e.g. clicking) that sub-field.

Accordingly, in an example implementation, the user may rely on the satellite information pane 430 during self-installation of a satellite receiver to select a particular satellite (e.g., based on availability and/or detailed information relating thereto).

FIG. 4B illustrates an example interface of an application for use in an electronic device during aligning of user-installed signal receivers. Referring to FIG. 4B, there is shown the electronic device 400 of FIG. 4A for example.

The self-install application run or executed by the electronic device 400 may be comprise functions for particularly aiding use, during self-installation of signal receivers (e.g., satellite dish), in aiming and aligning the signal receivers in the direction of particular signal source (e.g., satellite). In some instances, the aiming/alignment support may be provided by graphical/visual means. For example, as shown in FIG. 4B, the self-install application GUI 420 may comprise a ‘satellite alignment’ pane 460, which may comprise visual representation to aid the user in achieving perfect (or near-perfect) alignment with desired (selected) satellite. In an example implementation, the visual representation utilized in the ‘satellite alignment’ pane 460 may be based on bubble or level—i.e., displaying of a bubble or level that is utilized to guide an installer/user on how to optimally align the dish with the selected satellite by telling the user how the satellite dish (which is connected to the electronic device 400) need to be moved to achieve the alignment. For example, as shown in FIG. 4B, in an implementation of the invention, the ‘satellite alignment’ pane 460 may comprise a bubble 462, corresponding to the current alignment of the satellite dish, that may move along a series of horizontal and vertical bars 464 which may be utilized to guide a user on how to align the satellite dish with the selected satellite. For example, the intersect (cross) point of the horizontal and vertical bars 464 may correspond to the perfect alignment for the selected satellite, and thus the alignment may be achieved by moving the satellite dish until the bubble (which represent to the alignment of the satellite dish) is in the intersect point. The displaying of the ‘satellite alignment’ pane 460 may be triggered in various manners. For example, the ‘satellite alignment’ pane 460 may be displayed automatically once a satellite is selected (as described in FIG. 4A). Alternatively, the ‘satellite alignment’ pane 460 may be triggered based on express user input (e.g., by selecting or clicking a button, menu options, or the like in the self-install application GUI 420).

FIG. 4C illustrates another example interface of an application for use in an electronic device during aligning of user-installed signal receivers. Referring to FIG. 4C, there is shown the electronic device 400 of FIG. 4A for example, in which a self-install application may be run, having the self-install application GUI 420.

As shown in FIG. 4C, the self-install application GUI 420 may comprise a ‘satellite alignment’ pane 480, which may comprise a different implementation for utilizing visual/graphical interface to aid the user in achieving perfect (or near-perfect) alignment with a desired (selected) signal source (e.g., satellite). It should be understood that the implementations described in FIGS. 4B and 4C are non-limiting examples, and that any means for providing dynamic/real-time feedback to the user/installer during alignment of self-installed signal reception assemblies may be similarly utilized.

The ‘satellite alignment’ pane 480 may be based on, for example, displaying of a ‘current alignment indicator’ 486, which may indicate the current alignment relative to the desired perfect alignment. In this regard, the desired perfect alignment may be represented in the ‘satellite alignment’ pane 480 using alignment axes 482, which may comprise two axes (e.g., x and y), such that the intersect point (origin) 484 may correspond to the desired perfect alignment. The ‘satellite alignment’ pane 480 may be utilized to provide to the user installer/user a dynamic/real-time graphical indication of where the current alignment may be relative to the desired perfect alignment.

For example, once the satellite dish is installed, its initial alignment may correspond to position 490 within an alignment plane defined by the alignment axes 482. Knowing that the origin 484 correspond to the perfect alignment, the user/installer may move the satellite dish to achieve that perfect alignment, with that movement being represented in the ‘satellite alignment’ pane 480 by movement of the ‘current alignment indicator’ 486 within the alignment plane (as shown, by way of example, in FIG. 4C). The user/installer may continue to move the satellite dish until the ‘current alignment indicator’ 486 overlays the origin 484. In some instances, additional feedback (beside simply graphical feedback by means of overlaying) may be provided to indicate to the user/installer. For example, the ‘current alignment indicator’ 486 may be displayed in a particular manner when there is no perfect alignment (e.g., as red flashing circle), and then the ‘current alignment indicator’ 486 may be displayed in different manner once perfect alignment is achieved (e.g., as green solid circle). In addition, audio feedback may be used to further aid the user/installer. For example, as the ‘current alignment indicator’ 486 moves to non-perfect-alignment positions, the electronic device 400 may play particular sound (e.g., short beeps), and then when the perfect alignment is achieved (i.e. ‘current alignment indicator’ 486 overlays the origin 484) a different sound (e.g., long, steady beep) may be played.

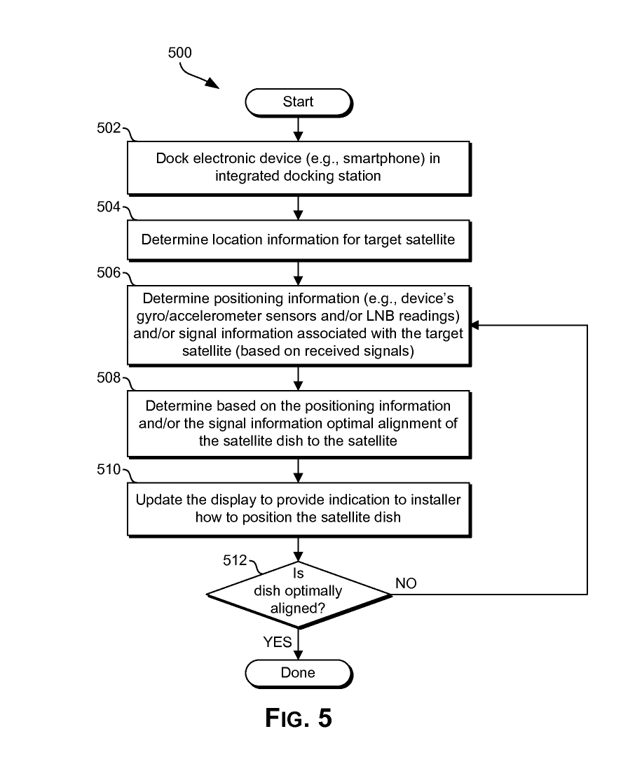

FIG. 5 is a flow chart that illustrates example process for alignment of a broadcast signal receiver utilizing an electronic device, in accordance with an exemplary implementation of the invention. Referring to FIG. 5, there is shown a flow chart 500 comprising a plurality of example steps for utilizing an electronic device (e.g., the electronic device 200) to support user self-install (and aiming) of signal receivers, such as satellite signal receiver (e.g., satellite dish 200).

In step 502, the electronic device (e.g., smartphone) may be docked in integrated docking station of the signal reception assembly (e.g., satellite dish). In step 504, location information for target signal source (e.g., satellite) may be determined. In this regard, the location information may be obtained from, for example, websites or other online data sources, such as using the electronic device. In step 506, positioning information for to the electronic device (and thus the satellite dish) and/or signal information associated with the target satellite (based on received signals) may be determined. In this regard, the positioning information may comprise location and/or directionality (three-dimensional) data, and since the electronic device is docked onto the satellite dish, its positioning information would correlate with the positioning of the satellite dish. The positioning information may be determined using, for example, sensors in the electronic device (e.g. gyro/accelerometer) and/or satellite dish (e.g., LNB) readings. The signal information may comprise parameter pertinent to aiming and/or aligning of the satellite dish (e.g., signal strength, noise, etc.).

In step 508, determine based on positioning information and/or the signal information optimal alignment of the satellite dish to the satellite. In step 510, the electronic device may update display of feedback to provide indication to installer how to position the dish based on positioning information. In step 512, it may then be determined whether the satellite dish is optimally aligned (e.g., whether the user adjusted the aiming and/or alignment of the dish according to the displayed feedback and/or whether changes in the satellite positioning caused changes in required adjustments). In instances where it may be determined that the satellite is optimally aligned, the process may terminate; otherwise, the process may loop back to step 506.

Other implementations may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for aiming and aligning self-installed broadcast signal receivers.

Accordingly, the present method and/or system may be realized in hardware, software, or a combination of hardware and software. The present method and/or system may be realized in a centralized fashion in at least one computer system, or in a distributed fashion where different elements are spread across several interconnected computer systems. Any kind of computer system or other system adapted for carrying out the methods described herein is suited. A typical combination of hardware and software may be a general-purpose computer system with a computer program that, when being loaded and executed, controls the computer system such that it carries out the methods described herein.

The present method and/or system may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present method and/or apparatus has been described with reference to certain implementations, it will be understood by those skilled in the art that various changes may be made and equivalents may be substituted without departing from the scope of the present method and/or apparatus. In addition, many modifications may be made to adapt a particular situation or material to the teachings of the present disclosure without departing from its scope. Therefore, it is intended that the present method and/or apparatus not be limited to the particular implementations disclosed, but that the present method and/or apparatus will include all implementations falling within the scope of the appended claims.

What is claimed is:

1. A method, comprising:
receiving by a signal reception assembly, signals originating from a particular signal source;
determining based on processing of the received signals, signal related data, wherein the signal related data comprises parameters pertinent to configuring reception of signals from the particular signal source;
obtaining by an electronic device that is coupled to the signal reception assembly, positioning information, wherein:
the positioning information comprise one or both of location and directionality related parameters, and
the electronic device is coupled to the signal reception assembly such that positioning of the electronic device correlates with positioning of the signal reception assembly; and
determining based on the positioning information and the signal related data, one or more adjustments to aiming and/or alignment of the signal reception assembly relative to the particular signal source.

2. The method of claim 1, wherein the signal reception assembly comprises a satellite reception assembly and the particular signal source comprises a satellite.

3. The method of claim 1, wherein the electronic device comprises a smartphone, a cellular phone, or a tablet.

4. The method of claim 1, comprising coupling the electronic device to the signal reception assembly by docking the electronic device onto a component of the signal reception assembly.

5. The method of claim 4, wherein the component of the signal reception assembly comprises a signal capturing component.

6. The method of claim 5, wherein the signal capturing component comprises a low noise block downconverter (LNB) when the signal reception assembly is a satellite reception assembly.

7. The method of claim 1, comprising processing the received signals, to obtain the signal related data, by the signal reception assembly and/or a separate signal processing device.

8. The method of claim 7, wherein the separate signal processing device comprises a broadband gateway, a satellite set-top box (STB), or a local network router.

9. The method of claim 1, comprising presenting by the electronic device the one or more adjustments to the aiming or alignment of the signal reception assembly to a user of the signal reception assembly.

10. The method of claim 1, comprising selecting the particular signal source by a user of the signal reception assembly.

11. The method of claim 10, comprising presenting by the electronic device the plurality of available signal sources to the user of the signal reception assembly.

12. The method of claim 1, comprising running by the electronic device an application for aiding a user of the signal reception assembly during selection, aiming, and/or aligning of the signal reception assembly.

13. A system, comprising:
one or more circuits for use in an electronic device, the one or more circuits being operable to:
determine positioning information associated with the electronic device, wherein positioning information comprise one or both of location and directionality related parameters; and
determine based on the positioning information, one or more adjustments to aiming and/or alignment of a signal reception assembly relative to a particular signal source, wherein:
the electronic device is coupled to the signal reception assembly such that positioning of the electronic device correlates with positioning of the signal reception assembly.

14. The system of claim 13, wherein the electronic device is coupled to the signal reception assembly by docking the electronic device onto a component of the signal reception assembly.

15. The system of claim 13, wherein the one or more circuits are operable to run an application for aiding a user of the signal reception assembly during selection, aiming, and/or aligning of the signal reception assembly.

16. The system of claim 13, wherein the one or more circuits are operable to determine the one or more adjustments to the aiming and/or alignment of the signal reception assembly signal related data that is obtained from processing of signals received by the signal reception assembly from the particular signal source.

17. The system of claim 13, wherein the one or more circuits are operable to present the one or more adjustments to the aiming or alignment of the signal reception assembly to a user of the signal reception assembly.

18. The system of claim 13, wherein the one or more circuits are operable to present a plurality of available signal sources to a user of the signal reception assembly.

19. The system of claim 18, wherein the one or more circuits are operable to receive from the user a selection of the particular signal source from the presented plurality of available signal sources.

20. A system, comprising:
a signal reception assembly that is operable to receive signals from one or more signal sources, wherein:
the signal reception assembly comprises a signal capturing component that is operable to captured the received signals, and the signal capturing component comprises a coupling element for enabling coupling of electronic devices to the signal reception assembly; and
the signal reception assembly supports user aiming and/or alignment, the user aiming and/or alignment process comprising:
setting the signal reception assembly for reception of signals from a particular signal source, based on initial aim and/or alignment settings;
adjusting aiming and/or alignment of the signal reception assembly based on presentation by an electronic device that is coupled to the signal reception assembly via the coupling element, of aim and/or alignment adjustment related information, wherein:
the electronic device is coupled to the signal reception assembly such that positioning of the electronic device correlates with positioning of the signal reception assembly; and
the aim and/or alignment adjustment related information is determined based on positioning information associated with the electronic device.

21. The system of claim 20, wherein the signal reception assembly is operable to receive, during the user aiming and/or alignment process, signals originating from the particular signal source, the received signals being processed to obtain signal related data that is utilized in determining the aim and/or alignment adjustment related information.

22. The system of claim 20, wherein the coupling element comprises a docking station that comprises a connector component.

23. The system of claim 22, wherein the connector component comprises a Universal Serial Bus (USB) connector.

24. The system of claim 20, wherein the signal reception assembly comprises a satellite reception assembly.

25. The method of claim 20, wherein the signal capturing component comprises a low noise block downconverter (LNB).
